(19) United States
(12) Patent Application Publication
(10) Pub. No.: US 2014/0244997 A1
(43) Pub. Date: Aug. 28, 2014

(54) EMERGENCY MODE FOR IOT DEVICES

(71) Applicant: QUALCOMM Incorporated, San Diego, CA (US)

(72) Inventors: Amit GOEL, San Diego, CA (US); Mohammed Ataur Rahman SHUMAN, San Diego, CA (US); Binita GUPTA, San Diego, CA (US); Ashutosh AGGARWAL, San Diego, CA (US); Sandeep SHARMA, San Diego, CA (US)

(73) Assignee: QUALCOMM Incorporated, San Diego, CA (US)

(21) Appl. No.: 14/187,978

(22) Filed: Feb. 24, 2014

Related U.S. Application Data
(60) Provisional application No. 61/769,115, filed on Feb. 25, 2013.

(51) Int. Cl. H04L 29/06

(52) U.S. Cl. CPC H04L 63/062
USPC 713/155

(57) ABSTRACT

Methods and apparatuses for implementing an emergency instruction based on an emergency message from a trusted authority source. The method includes receiving, at an Internet of Things (IoT) device, an emergency secret key from a trusted authority source The method receives, at an IoT device, an emergency message from the trusted authority source; decoding, at an IoT device, the emergency message from the trusted authority source using the emergency secret key to determine a value within the emergency message. The method calculates, at an IoT device, a result based on the determined value. The method implements, at an IoT device, an emergency instruction if the result is above a predetermined threshold.

The present application claims priority to U.S. Provisional Patent Application Ser. No. 61/769,115, entitled “EMERGENCY MODE FOR IOE DEVICES,” filed Feb. 25, 2013, assigned to the assignee hereof, and the contents of which are expressly incorporated herein by reference in their entirety.

### BACKGROUND OF THE INVENTION

1. Field of the Invention

The disclosure is directed to implementing an emergency instruction based on an emergency message from a trusted authority source.

2. Description of the Related Art

The Internet is a global system of interconnected computers and computer networks that use a standard Internet protocol suite (e.g., the Transmission Control Protocol (TCP) and Internet Protocol (IP)) to communicate with each other. The Internet of Things (IoT) is based on the idea that everyday objects, not just computers and computer networks, can be readable, recognizable, locatable, addressable, and controllable via an IoT communications network (e.g., an ad-hoc system or the Internet).

A number of market trends are driving development of IoT devices. For example, increasing energy costs are driving governments' strategic investments in smart grids and support for future consumption, such as for electric vehicles and public charging stations. Increasing health care costs and aging populations are driving development for remote/connected health care and fitness services. A technological revolution in the home is driving development for new “smart” services, including consolidation by service providers marketing ‘N’ play (e.g., data, voice, video, security, energy management, etc.) and expanding home networks. Buildings are getting smarter and more convenient as a means to reduce operational costs for enterprise facilities.

There are a number of key applications for the IoT. For example, in the area of smart grids and energy management, utility companies can optimize delivery of energy to homes and businesses while customers can better manage energy usage. In the area of home and building automation, smart homes and buildings can have centralized control over virtually any device or system in the home or office, from appliances to plug-in electric vehicle (PEV) security systems. In the field of asset tracking, enterprises, hospitals, factories, and other large organizations can accurately track the locations of high-value equipment, patients, vehicles, and so on. In the area of health and wellness, doctors can remotely monitor patients' health while people can track the progress of fitness routines.

### SUMMARY

The disclosure is directed to implementing an emergency instruction based on an emergency message from a trusted authority source.

For example, an exemplary embodiment is directed to a method for implementing an emergency instruction based on an emergency message from a trusted authority source, the method comprising: receiving, at an Internet of Things (IoT) device, an IoT secret key from a trusted authority source; receiving, at an IoT device, an emergency message from the trusted authority source, the emergency message comprising an emergency secret key; decoding, at an IoT device, the emergency message from the trusted authority source using the IoT secret key to determine a value within the emergency message; calculating, at an IoT device, a result based on the determined value; and implementing, at an IoT device, an emergency instruction if the result is above a predetermined threshold.

Another exemplary embodiment is directed to an apparatus comprising: a processor configured to implementing an emergency instruction based on an emergency message from a trusted authority source; logic configured to receive an IoT secret key from a trusted authority source; logic configured to receive an emergency message from the trusted authority source, wherein the emergency message comprises an emergency secret key; logic configured to decode the emergency message from the trusted authority source using the IoT secret key to determine a value within the emergency message; logic for calculating a result based on the determined value; and logic for implementing an emergency instruction if the result is above a predetermined threshold.

Still another exemplary embodiment is directed to a method for a trusted authority source to transmit an emergency message, the method comprising: receiving, from an outside source, an IoT secret key; transmitting, from the trusted authority source, the IoT secret key to at least one IoT device; receiving, from the outside source, an emergency secret key, wherein the emergency message comprises an emergency secret key; transmitting, from the trusted authority source, an emergency message to a subset of the at least one IoT device, wherein the emergency message comprises the secret key.

Yet another exemplary embodiment is directed to an apparatus comprising: a processor configured to transmit an emergency message to an IoT device; logic configured to receive an IoT secret key; logic configured to transmit the IoT secret key to at least one IoT device; logic configured to receive an emergency message, wherein the emergency message comprises an emergency secret key; and logic configured to transmit the emergency message to a subset of the at least one IoT device.

Some advantages to the present disclosure may be to provide a system of communication between trusted authorities (e.g., fire departments, police departments, gas companies) and IoT devices to ensure public safety and minimize damage. Communications may be beneficial in emergency situations including earthquakes, fires, floods, riots, and other disasters, both natural and manmade.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1A illustrates a high-level system architecture of a wireless communications system in accordance with an aspect of the disclosure.

FIG. 1B illustrates a high-level system architecture of a wireless communications system in accordance with an aspect of the disclosure.

FIG. 1C illustrates a high-level system architecture of a wireless communications system in accordance with an aspect of the disclosure.

FIG. 1D illustrates a high-level system architecture of a wireless communications system in accordance with an aspect of the disclosure.

FIG. 1E illustrates a high-level system architecture of a wireless communications system in accordance with an aspect of the disclosure.

FIG. 2A illustrates an exemplary Internet of Things (IoT) device in accordance with aspects of the disclosure, while FIG. 2B illustrates an exemplary passive IoT device in accordance with aspects of the disclosure.

FIG. 3 illustrates an operational flow of a method for implementing an emergency instruction based on an emergency message from a trusted authority source.

FIG. 4 illustrates a communication device that includes logic configured to implement an emergency instruction based on an emergency message from a trusted authority source.

FIG. 5 illustrates an exemplary server to transmit an emergency instruction to an IoT device.

FIG. 6 illustrates an operational flow of a method for transmitting an emergency instruction to an IoT device.

FIG. 7 illustrates a communication device display that shows emergency message information from the trusted authority source regarding the device.

### DETAILED DESCRIPTION

Various aspects are disclosed in the following description and related drawings. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the term “Internet of Things (IoT) device” is used to refer to an electronic device (e.g., an appliance, a sensor, etc.) with a particular set of device attributes (e.g., a cooling or heating function, an environmental monitoring or recording function, a light-emitting function, a sound-emitting function, etc.) that can be embedded with and/or controlled/monitored by a central processing unit (CPU), microprocessor, application specific integrated circuit (ASIC), or the like, and configured for connection to an IoT network such as a local ad-hoc network or the Internet. For example, IoT devices may include, but are not limited to, refrigerators, toasters, ovens, microwaves, freezers, dishwashers, clothes washers, clothes dryers, furnaces, air conditioners, thermostats, televisions, light fixtures, vacuum cleaners, electricity meters, gas meters, etc., so long as the devices are equipped with a communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

A “trusted authority source” is a source of data for IoT devices. For example, a trusted authority source can be a server. An individual or an entity can have sole access to the trusted authority source. For example, the individual can be a mayor, a governor, a Chief Information Officer of a corporation, a chief-of-police, or a fire chief. An entity can be the local fire department, the local police department, an energy provider (e.g., a gas or electric company), the Forest Service, FEMA, the National Weather Service, the Department of Defense, or the Department of Homeland Security.

These individuals and entities can each act as an “outside source.” An outside source can also transmit to the trusted authority source through a secure web interface. In an embodiment, an individual can provide data to the trusted authority source. The individual can manually enter a command that includes an IoT token. The individual can use an external memory device (e.g., a memory stick, an external drive) or provide another source, such as a voice command or a visual item to be scanned (e.g., a picture, retinal scan, a barcode, a QR code) to provide the data.

This data from an outside source is an “IoT Secret Key”. The trusted authority source can transmit an emergency secret key that an IoT device can store in memory. The emergency secret key is encrypted using the above IoT secret key for secure transmission and for certification that it is originating from trusted authority with which the IoT secret key was shared. The trusted authority source can then transmit an emergency message including the emergency secret key to the IoT device. The IoT device can decode an emergency message sent from a trusted source using its stored emergency secret key. In some embodiments, the trusted authority source can transmit the emergency message to multiple IoT devices in a broadcast/multicast/unicast message. For example, the trusted authority source can transmit the emergency message to only specific types of IoT devices, such as devices that run off of natural gas. The trusted authority can also transmit the emergency message to IoT devices within a specified area, such as certain city blocks.

Once an IoT device has decoded the emergency message, the IoT device can determine whether to implement an emergency instruction based on the emergency message. The emergency instruction can include such instructions as a shut-off instruction or a turn-on instruction. For example, an oven would shut off gas in case of an earthquake with a magnitude of 8.0 or higher on the Richter scale. In some embodiments, the emergency instruction can be to increase or decrease output. For example, to respond to a rolling brownout emergency message, the emergency instruction can be to reduce an air conditioning device's output so that the device keeps the temperature below 80° F. rather than 70° F. The emergency instruction can include an alert instruction, such as an instruction for a thermostat to issue an audible alert to a user that the heat should be increased in order to prevent pipe bursts because the temperature will drop that evening.

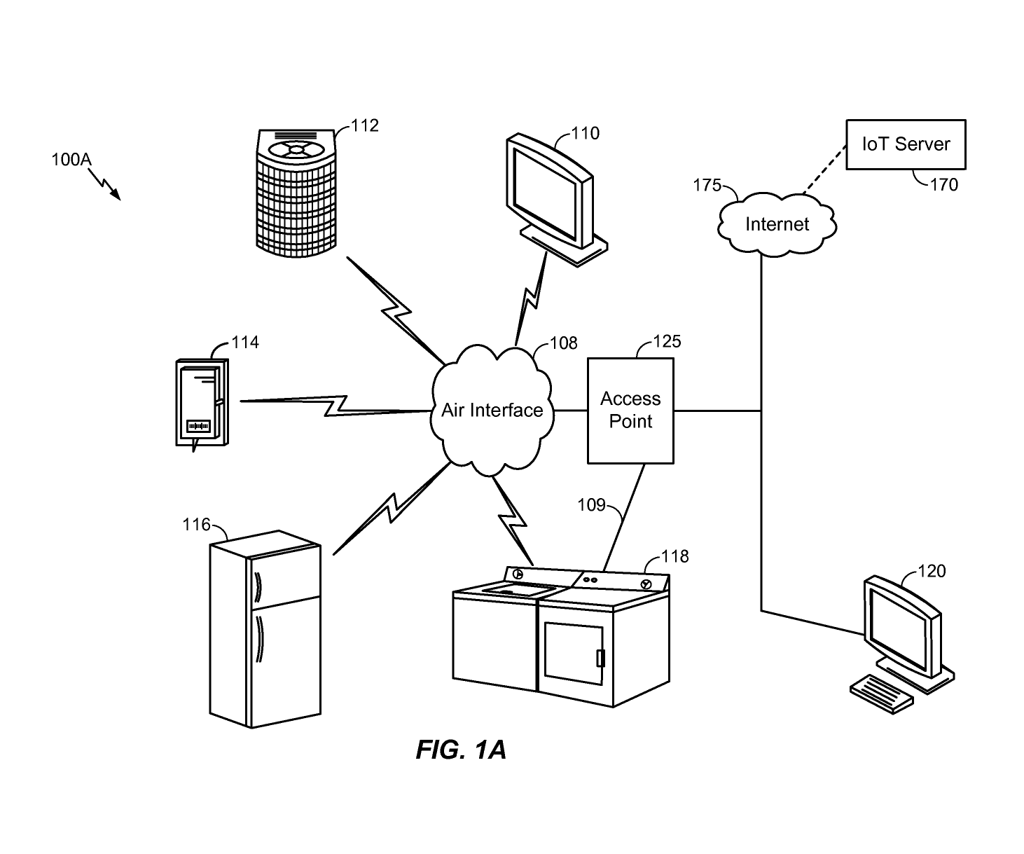

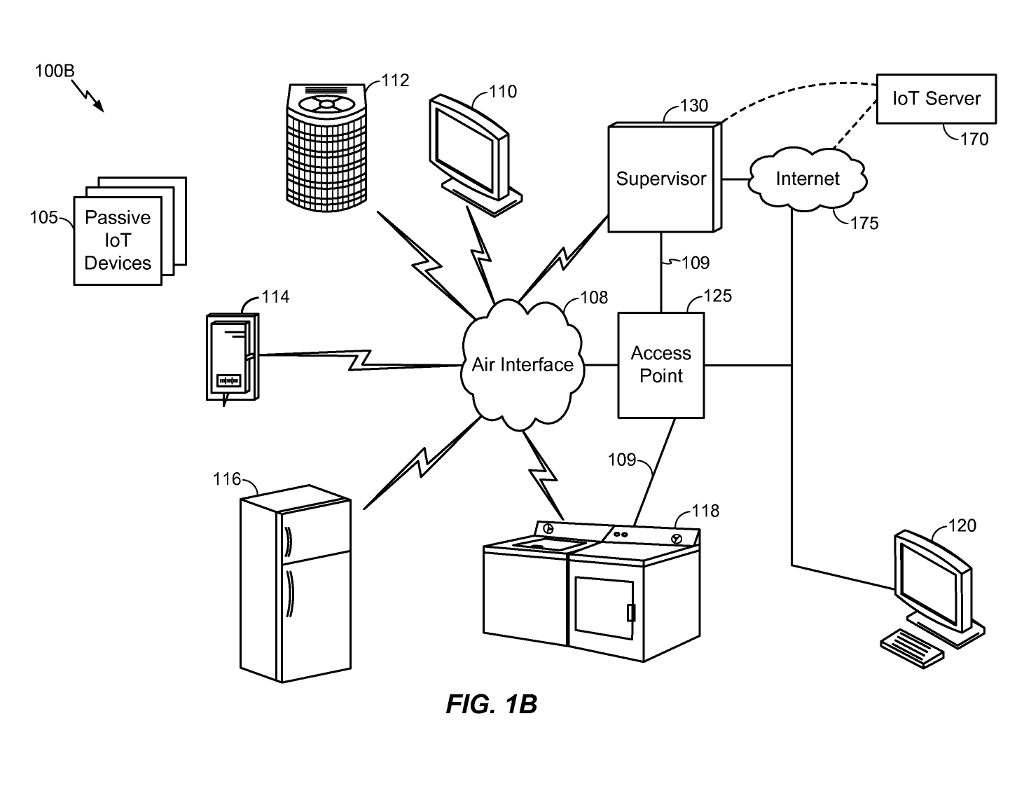

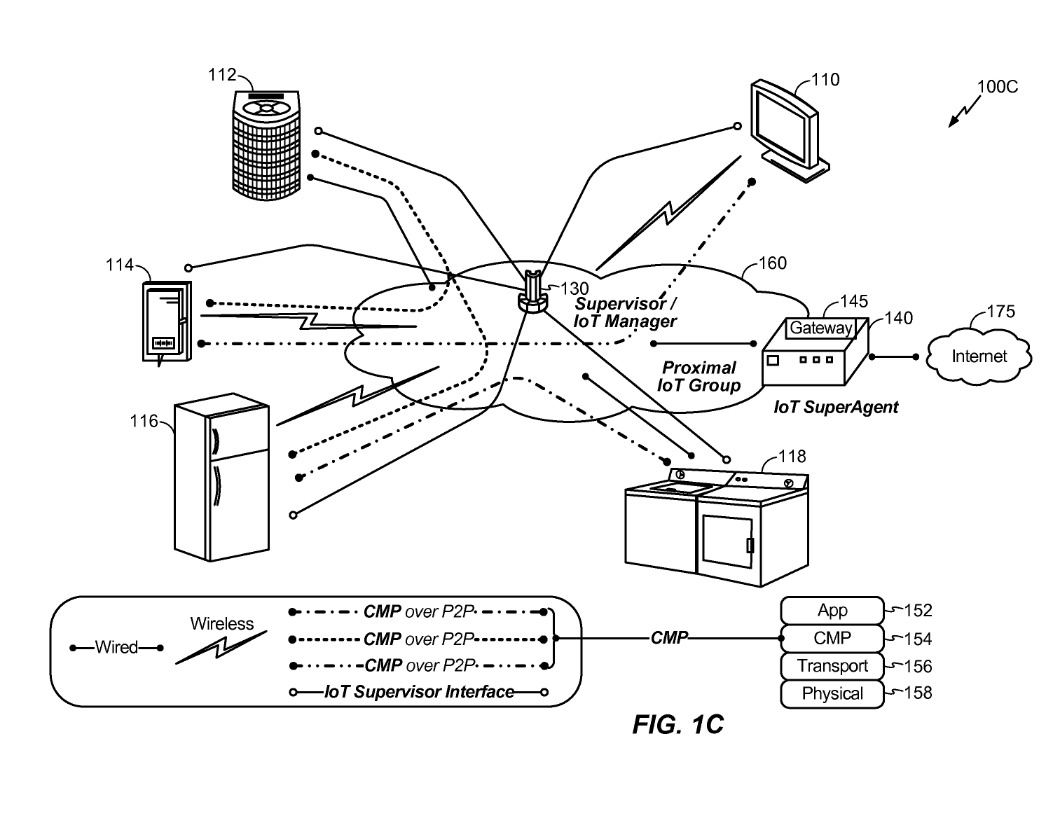

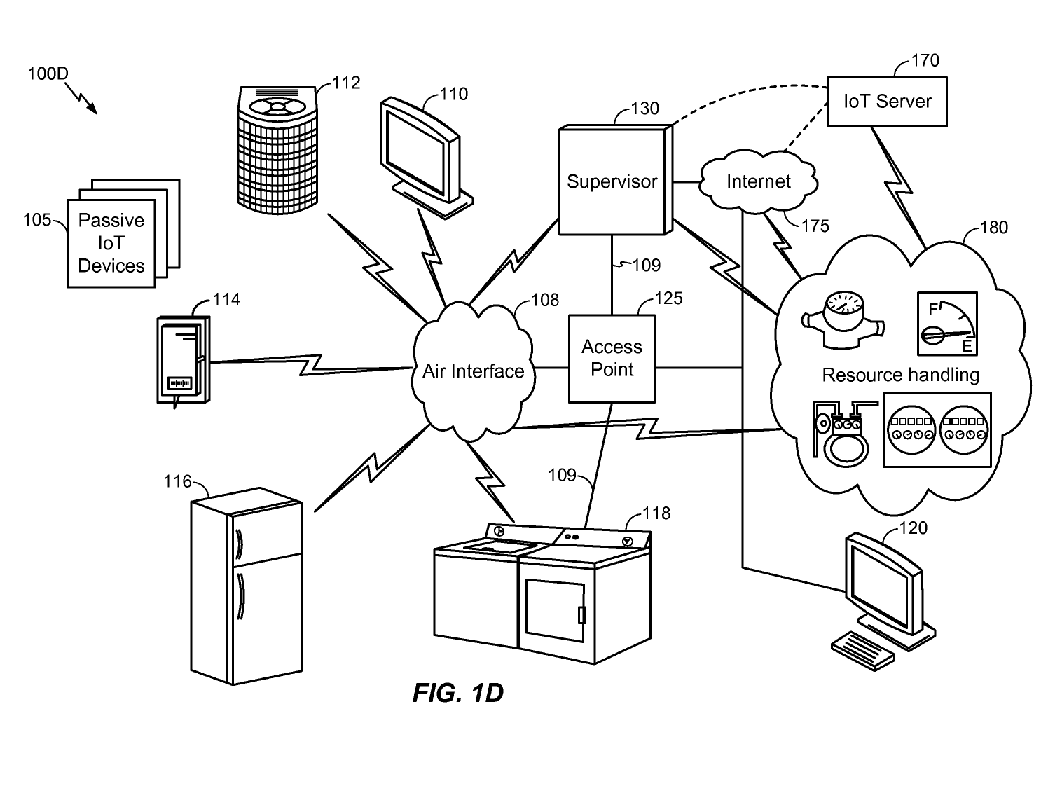

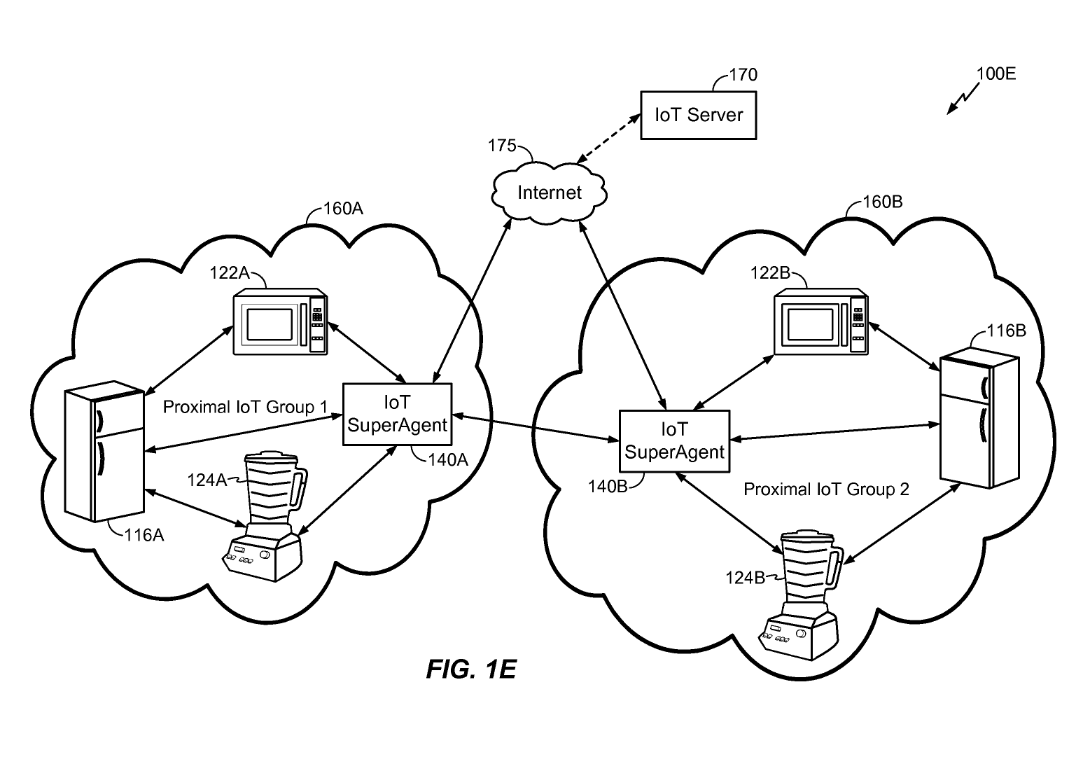

FIG. 1A illustrates a high-level system architecture of a wireless communications system 100A in accordance with an aspect of the disclosure. The wireless communications system 100A contains a plurality of IoT devices, which include a television 110, an outdoor air conditioning unit 112, a thermostat 114, a refrigerator 116, and a washer and dryer 118.

Referring to FIG. 1A, IoT devices 110-118 are configured to communicate with an access network (e.g., an access point 125) over a physical communications interface or layer, shown in FIG. 1A as air interface 108 and a direct wired connection 109. The air interface 108 can comply with a wireless Internet protocol (IP), such as IEEE 802.11. Although FIG. 1A illustrates IoT devices 110-118 communicating over the air interface 108 and IoT device 118 communicating over the wired connection 109, each IoT device may communicate over a wired or wireless connection, or both.

The Internet 175 includes a number of routing agents and processing agents (not shown in FIG. 1A for the sake of convenience). The Internet 175 is a global system of interconnected computers and computer networks that uses a standard Internet protocol suite (e.g., the Transmission Control Protocol (TCP) and IP) to communicate among disparate devices/networks. TCP/IP provides end-to-end connectivity specifying how data should be formatted, addressed, transmitted, routed and received at the destination.

In FIG. 1A, a computer 120, such as a desktop or personal computer (PC), is shown as connecting to the Internet 175 directly (e.g., over an Ethernet connection or Wi-Fi or 802.11-based network). The computer 120 may have a wired connection to the Internet 175, such as a direct connection to a modem or router, which, in an example, can correspond to the access point 125 itself (e.g., for a Wi-Fi router with both wired and wireless connectivity). Alternatively, rather than being connected to the access point 125 and the Internet 175 over a wired connection, the computer 120 may be connected to the access point 125 over air interface 108 or another wireless interface, and access the Internet 175 over the air interface. Although illustrated as a desktop computer, computer 120 may be a laptop computer, a tablet computer, a PDA, a smart phone, or the like. The computer 120 may be an IoT device and/or contain functionality to manage an IoT network/group, such as the network/group of IoT devices 110-118.

The access point 125 may be connected to the Internet 175 via, for example, an optical communication system, such as FiOS, a cable modem, a digital subscriber line (DSL) modem, or the like. The access point 125 may communicate with IoT devices 110-118/120 and the Internet 175 using the standard Internet protocols (e.g., TCP/IP).

Referring to FIG. 1A, an IoT server 170 is shown as connected to the Internet 175. The IoT server 170 can be implemented as a plurality of structurally separate servers, or alternately may correspond to a single server. In an aspect, the IoT server 170 is optional (as indicated by the dotted line), and the group of IoT devices 110-118/120 may be a peer-to-peer (P2P) network. In such a case, the IoT devices 110-118/120 can communicate with each other directly over the air interface 108 and/or the wired connection 109. Alternatively, or additionally, some or all of IoT devices 110-118/120 may be configured with a communication interface independent of air interface 108 and wired connection 109. For example, if the air interface 108 corresponds to a WiFi interface, certain of the IoT devices 110-118/120 may have Bluetooth or NFC interfaces for communicating directly with each other or other Bluetooth or NFC-enabled devices.

In a peer-to-peer network, service discovery schemes can multicast the presence of nodes, their capabilities, and group membership. The peer-to-peer devices can establish associations and subsequent interactions based on this information.

In accordance with an aspect of the disclosure, FIG. 1B illustrates a high-level architecture of another wireless communications system 100B that contains a plurality of IoT devices. In general, the wireless communications system 100B shown in FIG. 1B may include various components that are the same and/or substantially similar to the wireless communications system 100A shown in FIG. 1A, which was described in greater detail above (e.g., various IoT devices, including a television 110, outdoor air conditioning unit 112, thermostat 114, refrigerator 116, and washer and dryer 118, that are configured to communicate with an access point 125 over an air interface 108 and/or a direct wired connection 109, a computer 120 that directly connects to the Internet 175 and/or connects to the Internet through access point 125, and an IoT server 170 accessible via the Internet 175, etc.). As such, for brevity and ease of description, various details relating to certain components in the wireless communications system 100B shown in FIG. 1B may be omitted herein to the extent that the same or similar details have already been provided above in relation to the wireless communications system 100A illustrated in FIG. 1A.

Referring to FIG. 1B, the wireless communications system 100B may include a supervisor device 130 that may be used to observe, monitor, control, or otherwise manage the various other components in the wireless communications system 100B. For example, the supervisor device 130 can communicate with an access network (e.g., access point 125) over air interface 108 and/or a direct wired connection 109 to monitor or manage attributes, activities, or other states associated with the various IoT devices 110-118/120 in the wireless communications system 100B. The supervisor device 130 may have a wired or wireless connection to the Internet 175 and optionally to the IoT server 170 (shown as a dotted line). The supervisor device 130 may obtain information from the Internet 175 and/or the IoT server 170 that can be used to further monitor or manage attributes, activities, or other states associated with the various IoT devices 110-118/120. The supervisor device 130 may be a standalone device or one of IoT devices 110-118/120, such as computer 120. The supervisor device 130 may be a physical device or a software application running on a physical device. The supervisor device 130 may include a user interface that can output information relating to the monitored attributes, activities, or other states associated with the IoT devices 110-118/120 and receive input information to control or otherwise manage the attributes, activities, or other states associated therewith. Accordingly, the supervisor device 130 may generally include various components and support various wired and wireless communication interfaces to observe, monitor, control, or otherwise manage the various components in the wireless communications system 100B.

The wireless communications system 100B shown in FIG. 1B may include one or more passive IoT devices 105 (in contrast to the active IoT devices 110-118/120) that can be coupled to or otherwise made part of the wireless communications system 100B. In general, the passive IoT devices 105 may include barcoded devices, Bluetooth devices, radio frequency (RF) devices, RFID tagged devices, infrared (IR) devices, NFC tagged devices, or any other suitable device that can provide its identifier and attributes to another device when queried over a short range interface. Active IoT devices may detect, store, communicate, act on, and/or the like, changes in attributes of passive IoT devices.

For example, passive IoT devices 105 may include a coffee cup and a container of orange juice that each have an RFID tag or barcode. A cabinet IoT device and the refrigerator IoT device 116 may each have an appropriate scanner or reader that can read the RFID tag or barcode to detect when the coffee cup and/or the container of orange juice passive IoT devices 105 have been added or removed. In response to the cabinet IoT device detecting the removal of the coffee cup passive IoT device 105 and the refrigerator IoT device 116 detecting the removal of the container of orange juice passive IoT device, the supervisor device 130 may receive one or more signals that relate to the activities detected at the cabinet IoT device and the refrigerator IoT device 116. The supervisor device 130 may then infer that a user is drinking orange juice from the coffee cup and/or likes to drink orange juice from a coffee cup.

Although the foregoing describes the passive IoT devices 105 as having some form of RF or barcode communication interfaces, the passive IoT devices 105 may include one or more devices or other physical objects that do not have such communication capabilities. For example, certain IoT devices may have appropriate scanner or reader mechanisms that can detect shapes, sizes, colors, and/or other observable features associated with the passive IoT devices 105 to identify the passive IoT devices 105. In this manner, any suitable physical object may communicate its identity and attributes and become part of the wireless communication system 100B and be observed, monitored, controlled, or otherwise managed with the supervisor device 130. Further, passive IoT devices 105 may be coupled to or otherwise made part of the wireless communications system 100A shown in FIG. 1A and observed, monitored, controlled, or otherwise managed in a substantially similar manner.

In accordance with another aspect of the disclosure, FIG. 1C illustrates a high-level architecture of another wireless communications system 100C that contains a plurality of IoT devices. In general, the wireless communications system 100C shown in FIG. 1C may include various components that are the same and/or substantially similar to the wireless communications systems 100A and 100B shown in FIGS. 1A and 1B, respectively, which were described in greater detail above. As such, for brevity and ease of description, various details relating to certain components in the wireless communications system 100C shown in FIG. 1C may be omitted herein to the extent that the same or similar details have already been provided above in relation to the wireless communications systems 100A and 100B illustrated in FIGS. 1A and 1B, respectively.

The communications system 100C shown in FIG. 1C illustrates exemplary peer-to-peer communications between the IoT devices 110-118 and the supervisor device 130. As shown in FIG. 1C, the supervisor device 130 communicates with each of the IoT devices 110-118 over an IoT supervisor interface. Further, IoT devices 110 and 114, IoT devices 112, 114, and 116, and IoT devices 116 and 118, communicate directly with each other.

The IoT devices 110-118 make up a proximal IoT group 160. A proximal IoT group is a group of locally connected IoT devices, such as the IoT devices connected to a user's home network. Although not shown, multiple proximal IoT groups may be connected to and/or communicate with each other via an IoT SuperAgent 140 connected to the Internet 175. At a high level, the supervisor device 130 manages intra-group communications, while the IoT SuperAgent 140 can manage inter-group communications. Although shown as separate devices, the supervisor 130 and the IoT SuperAgent 140 may be, or reside on, the same device. This may be a standalone device or an IoT device, such as computer 120 in FIG. 1A. Alternatively, the IoT SuperAgent 140 may correspond to or include the functionality of the access point 125. As yet another alternative, the IoT SuperAgent 140 may correspond to or include the functionality of an IoT server, such as IoT server 170. The IoT SuperAgent 140 may encapsulate gateway functionality 145.

Each IoT device 110-118 can treat the supervisor device 130 as a peer and transmit attribute/schema updates to the supervisor device 130. When an IoT device needs to communicate with another IoT device, it can request the pointer to that IoT device from the supervisor device 130 and then communicate with the target IoT device as a peer. The IoT devices 110-118 communicate with each other over a peer-to-peer communication network using a common messaging protocol (CMP). As long as two IoT devices are CMP-enabled and connected over a common communication transport, they can communicate with each other. In the protocol stack, the CMP layer 154 is below the application layer 152 and above the transport layer 156 and the physical layer 158.

In accordance with another aspect of the disclosure, FIG. 1D illustrates a high-level architecture of another wireless communications system 100D that contains a plurality of IoT devices. In general, the wireless communications system 100D shown in FIG. 1D may include various components that are the same and/or substantially similar to the wireless communications systems 100A-C shown in FIGS. 1A-C, respectively, which were described in greater detail above. As such, for brevity and ease of description, various details relating to certain components in the wireless communications system 100D shown in FIG. 1D may be omitted herein to the extent that the same or similar details have already been provided above in relation to the wireless communications systems 100A-C illustrated in FIGS. 1A-C, respectively.

The Internet is a “resource” that can be regulated using the concept of the IoT. However, the Internet is just one example of a resource that is regulated, and any resource could be regulated using the concept of the IoT. Other resources that can be regulated include, but are not limited to, electricity, gas, storage, security, and the like. An IoT device may be connected to the resource and thereby regulate it, or the resource could be regulated over the Internet. FIG. 1D illustrates several resources 180, such as natural gas, gasoline, hot water, and electricity, that can be regulated in addition to the Internet 175, or that can be regulated over the Internet 175.

IoT devices can communicate with each other to regulate their use of a resource. For example, IoT devices such as a toaster, a computer, and a hairdryer may communicate with each other over a Bluetooth communication interface to regulate their use of electricity (the resource). As another example, IoT devices such as a desktop computer, a telephone, and a tablet computer may communicate over a WiFi communication interface to regulate their access to the Internet (the resource). As yet another example, IoT devices such as a stove, a clothes dryer, and a water heater may communicate over a WiFi communication interface to regulate their use of gas. Alternatively, or additionally, each IoT device may be connected to an IoT server, such as IoT server 170, that has logic to regulate their use of the resource based on information received from the IoT devices.

In accordance with another aspect of the disclosure, FIG. 1E illustrates a high-level architecture of another wireless communications system 100E that contains a plurality of IoT devices. In general, the wireless communications system 100E shown in FIG. 1E may include various components that are the same and/or substantially similar to the wireless communications systems 100A-D shown in FIGS. 1A-D, respectively, which were described in greater detail above. As such, for brevity and ease of description, various details relating to certain components in the wireless communications system 100E shown in FIG. 1E may be omitted herein to the extent that the same or similar details have already been provided above in relation to the wireless communications systems 100A-D illustrated in FIGS. 1A-D, respectively.

The communications system 100E includes two proximal IoT groups 160A and 160B. Multiple proximal IoT groups may be connected to and/or communicate with each other via an IoT SuperAgent connected to the Internet 175. At a high level, an IoT SuperAgent manages inter-group communications. In FIG. 1E, the proximal IoT group 160A includes IoT devices 116A, 122A, and 124A and an IoT SuperAgent 140A. The proximal IoT group 160B includes IoT devices 116B, 122B, and 124B and an IoT SuperAgent 140B. IoT SuperAgents 140A and 140B are connected to Internet 175 and may communicate with each other over the Internet 175 or directly. The IoT SuperAgents 140A and 140B facilitate communication between the proximal IoT groups 160A and 160B. Although FIG. 1E illustrates two proximal IoT groups communicating with each other via IoT SuperAgents 160A and 160B, any number of proximal IoT groups may communicate with each other using IoT SuperAgents.

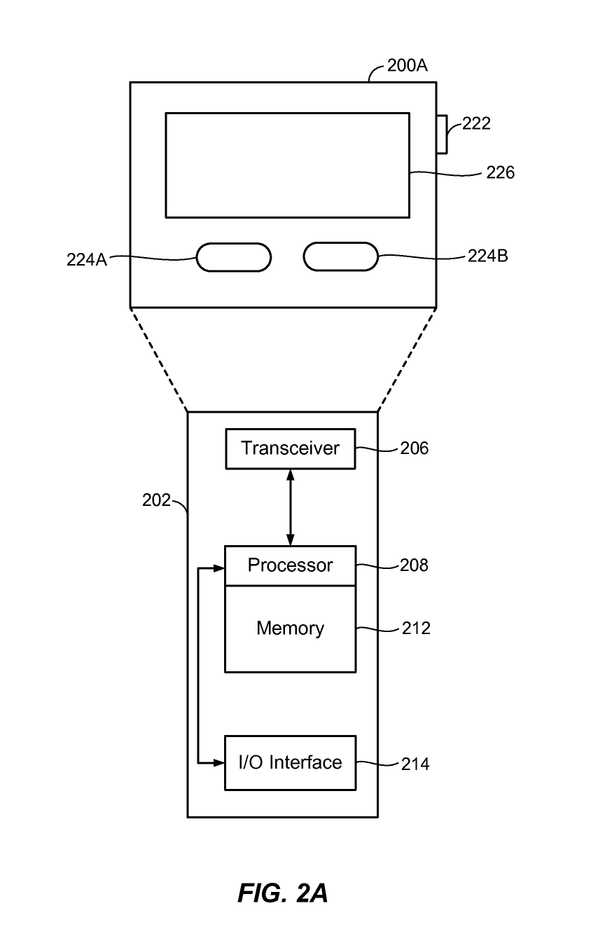

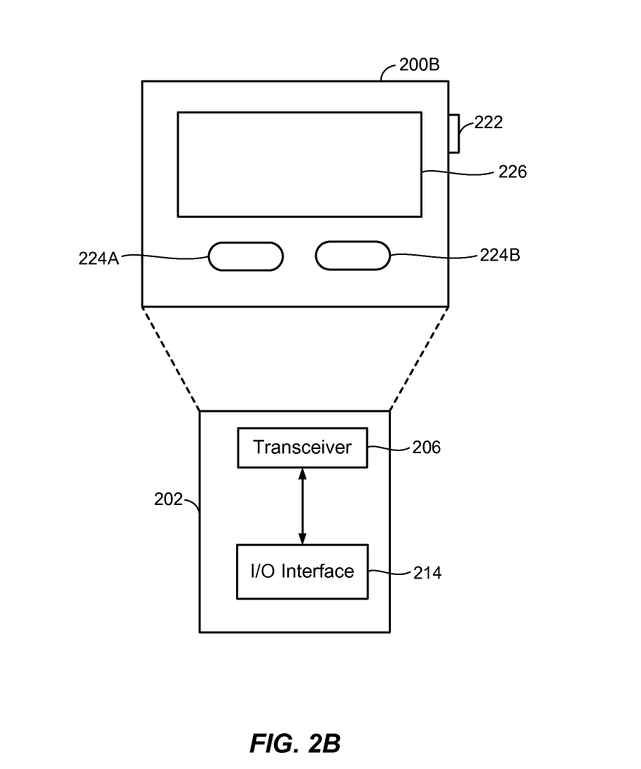

FIG. 2A illustrates a high-level example of an IoT device 200A in accordance with aspects of the disclosure. While external appearances and/or internal components can differ significantly among IoT devices, most IoT devices will have some sort of user interface, which may comprise a display and a means for user input. IoT devices without a user interface can be communicated with remotely over a wired or wireless network, such as air interface 108 in FIGS. 1A-B and D.

As shown in FIG. 2A, in an example configuration for the IoT device 200A, an external casing of IoT device 200A may be configured with a display 226, a power button 222, and two control buttons 224A and 224B, among other components, as is known in the art. The display 226 may be a touchscreen display, in which case the control buttons 224A and 224B may not be necessary. While not shown explicitly as part of IoT device 200A, the IoT device 200A may include one or more external antennas and/or one or more integrated antennas that are built into the external casing, including but not limited to Wi-Fi antennas, cellular antennas, satellite position system (SPS) antennas (e.g., global positioning system (GPS) antennas), and so on.

While internal components of IoT devices, such as IoT device 200A, can be embodied with different hardware configurations, a basic high-level configuration for internal hardware components is shown as platform 202 in FIG. 2A. The platform 202 can receive and execute software applications, data and/or commands transmitted over a network interface, such as air interface 108 in FIGS. 1A-B and D and/or a wired interface. The platform 202 can also independently execute locally stored applications. The platform 202 can include one or more transceivers 206 configured for wired and/or wireless communication (e.g., a Wi-Fi transceiver, a Bluetooth transceiver, a cellular transceiver, a satellite transceiver, a GPS or SPS receiver, etc.) operably coupled to one or more processors 208, such as a microcontroller, microprocessor, application specific integrated circuit, digital signal processor (DSP), programmable logic circuit, or other data processing device, which will be generally referred to as processor 208. The processor 208 can execute application programming instructions within a memory 212 of the IoT device. The memory 212 can include one or more of read-only memory (ROM), random-access memory (RAM), electrically erasable programmable ROM (EEPROM), flash cards, or any memory common to computer platforms. One or more input/output (I/O) interfaces 214 can be configured to allow the processor 208 to communicate with and control from various I/O devices such as the display 226, power button 222, control buttons 224A and 224B as illustrated, and any other devices, such as sensors, actuators, relays, valves, switches, and the like associated with the IoT device 200A.

Accordingly, an aspect of the disclosure can include an IoT device (e.g., IoT device 200A) including the ability to perform the functions described herein. As will be appreciated by those skilled in the art, the various logic elements can be embodied in discrete elements, software modules executed on a processor (e.g., processor 208) or any combination of software and hardware to achieve the functionality disclosed herein. For example, transceiver 206, processor 208, memory 212, and I/O interface 214 may all be used cooperatively to load, store and execute the various functions disclosed herein and thus the logic to perform these functions may be distributed over various elements. Alternatively, the functionality could be incorporated into one discrete component. Therefore, the features of the IoT device 200A in FIG. 2A are to be considered merely illustrative and the disclosure is not limited to the illustrated features or arrangement.

FIG. 2B illustrates a high-level example of a passive IoT device 200B in accordance with aspects of the disclosure. In general, the passive IoT device 200B shown in FIG. 2B may include various components that are the same and/or substantially similar to the IoT device 200A shown in FIG. 2A, which was described in greater detail above. As such, for brevity and ease of description, various details relating to certain components in the passive IoT device 200B shown in FIG. 2B may be omitted herein to the extent that the same or similar details have already been provided above in relation to the IoT device 200A illustrated in FIG. 2A.

The passive IoT device 200B shown in FIG. 2B may generally differ from the IoT device 200A shown in FIG. 2A in that the passive IoT device 200B may not have a processor, internal memory, or certain other components. Instead, in one embodiment, the passive IoT device 200A may only include an I/O interface 214 or other suitable mechanism that allows the passive IoT device 200B to be observed, monitored, controlled, managed, or otherwise known within a controlled IoT network. For example, in one embodiment, the I/O interface 214 associated with the passive IoT device 200B may include a barcode, Bluetooth interface, radio frequency (RF) interface, RFID tag, IR interface, NFC interface, or any other suitable I/O interface that can provide an identifier and attributes associated with the passive IoT device 200B to another device when queried over a short range interface (e.g., an active IoT device, such as IoT device 200A, that can detect, store, communicate, act on, or otherwise process information relating to the attributes associated with the passive IoT device 200B).

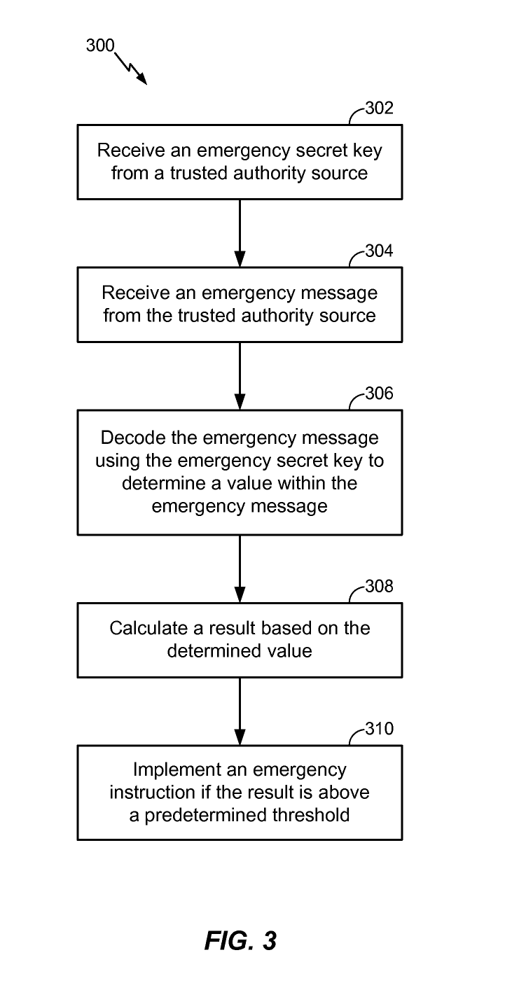

Although the foregoing describes the passive IoT device 200B as having some form of RF, barcode, or other I/O interface 214, the passive IoT device 200B may comprise a device or other physical object that does not have such an I/O interface 214. For example, certain IoT devices may have appropriate scanner or reader mechanisms that can detect shapes, sizes, colors, and/or other observable features associated with the passive IoT device 200B to identify the passive IoT device 200B. In this manner, any suitable physical object may communicate its identity and attributes and be observed, monitored, controlled, or otherwise managed within a controlled IoT network. FIG. 3 illustrates a communication device 300 that includes logic configured to perform functionality. The communication device 300 can correspond to any of the above-noted communication devices, including but not limited to IoT devices 110-118/120, IoT devices 200A and 200B, any components coupled to the Internet 175 (e.g., the IoT server 170), and so on. Thus, communication device 300 can correspond to any electronic device that is configured to communicate with (or facilitate communication with) one or more other entities over the wireless communications systems 100A-B and D of FIGS. 1A-B and D.

As illustrated in FIG. 3, an embodiment can include a method for implementing an emergency instruction based on an emergency message from a trusted authority source comprising: receiving an IoT secret key from a trusted authority source (e.g., from a firehouse server)—Block 302; receiving an emergency message comprising an emergency secret key from the trusted authority source (e.g., receiving the location of a gas leak in an emergency message from the firehouse server, where the emergency secret key is encrypted in the IoT device's secret key)—Block 304; decoding the emergency message using the IoT secret key to determine a value within the emergency message (e.g., using the IoT secret key to decode the location of the gas leak)—Block 306; calculating a result based on the determined value (e.g., determining whether or not that gas leak is part of the same gas main the device uses)—Block 308; and implementing an emergency instruction if the result is above a predetermined threshold (e.g., shutting off the gas intake valve if the gas leak is within the same gas main system as the device)—Block 310.

In some embodiments, the IoT device can receive data from other sources to calculate the result. For example, the IoT device can be a thermostat and use the current room temperature as part of the calculation of the result. An object that is not considered an IoT device can also provide data to calculate the result. For example, an outdoor thermometer can provide data to the thermostat even if it is not an everyday device. Data can also be provided from another everyday device, from the trusted authority source, or another trusted authority source.

In some embodiments, the value can be used as a variable in an equation to determine whether to implement the emergency instruction. For example, if the everyday device is a thermostat, and the emergency message provides data regarding a snowstorm, the thermostat can use data from the outdoor thermometer, its own thermometer to determine room temperature, and data from the emergency message to calculate the emergency instruction. The thermostat can be set to turn off at 10:00 AM, turn on low 4:00 PM, and turn on to a medium level at 5:00 PM. In an emergency mode, the thermostat can determine, based on all the data provided, that it should turn the heat on at 2:00 PM to low, 4:00 PM to medium level, and 5:00 PM to high level to ensure that pipes do not freeze without having heat run constantly.

In some embodiments, a different IoT secret key is sent periodically to an IoT device. For example, a new key is sent daily, but each day, it is updated from a different trusted authority source. The IoT secret key can be sent from multiple trusted authority sources to validate the key.

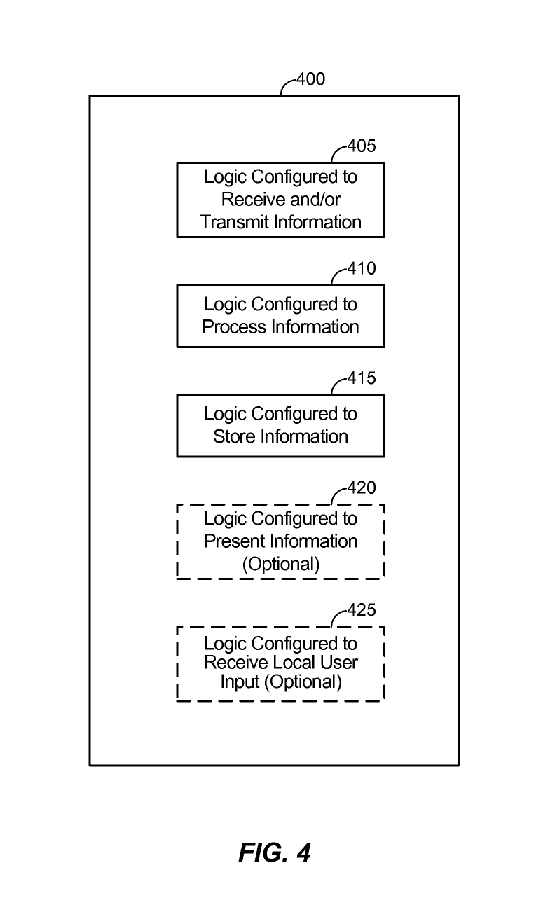

FIG. 4 illustrates a communication device 400 that includes logic configured to perform functionality. The communication device 400 can correspond to any of the above-noted communication devices, including but not limited to IoT devices 110-118/120, IoT device 200A, any components coupled to the Internet 175 (e.g., the IoT server 170), and so on. Thus, communication device 400 can correspond to any electronic device that is configured to communicate with (or facilitate communication with) one or more other entities over the wireless communications systems 100A-E of FIGS. 1A-E.

Referring to FIG. 4, the communication device 400 includes logic configured to receive and/or transmit information 405. In an example, if the communication device 400 corresponds to a wireless communications device (e.g., IoT device 200A and/or passive IoT device 200B), the logic configured to receive and/or transmit information 405 can include a wireless communications interface (e.g., Bluetooth, Wi-Fi, Wi-Fi Direct, Long-Term Evolution (LTE) Direct, etc.) such as a wireless transceiver and associated hardware (e.g., an RF antenna, a MODEM, a modulator and/or demodulator, etc.). In another example, the logic configured to receive and/or transmit information 405 can correspond to a wired communications interface (e.g., a serial connection, a USB or Firewire connection, an Ethernet connection through which the Internet 175 can be accessed, etc.). Thus, if the communication device 400 corresponds to some type of network-based server (e.g., the IoT server 170), the logic configured to receive and/or transmit information 405 can correspond to an Ethernet card, in an example, that connects the network-based server to other communication entities via an Ethernet protocol. In a further example, the logic configured to receive and/or transmit information 405 can include sensory or measurement hardware by which the communication device 400 can monitor its local environment (e.g., an accelerometer, a temperature sensor, a light sensor, an antenna for monitoring local RF signals, etc.). The logic configured to receive and/or transmit information 405 can also include software that, when executed, permits the associated hardware of the logic configured to receive and/or transmit information 405 to perform its reception and/or transmission function(s). However, the logic configured to receive and/or transmit information 405 does not correspond to software alone, and the logic configured to receive and/or transmit information 405 relies at least in part upon hardware to achieve its functionality.

Referring to FIG. 4, the communication device 400 further includes logic configured to process information 410. In an example, the logic configured to process information 410 can include at least a processor. Example implementations of the type of processing that can be performed by the logic configured to process information 410 includes but is not limited to performing determinations, establishing connections, making selections between different information options, performing evaluations related to data, interacting with sensors coupled to the communication device 400 to perform measurement operations, converting information from one format to another (e.g., between different protocols such as .wmv to .avi, etc.), and so on. For example, the processor included in the logic configured to process information 410 can correspond to a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). The logic configured to process information 410 can also include software that, when executed, permits the associated hardware of the logic configured to process information 410 to perform its processing function(s). However, the logic configured to process information 410 does not correspond to software alone, and the logic configured to process information 410 relies at least in part upon hardware to achieve its functionality.

Referring to FIG. 4, the communication device 400 further includes logic configured to store information 415. In an example, the logic configured to store information 415 can include at least a non-transitory memory and associated hardware (e.g., a memory controller, etc.). For example, the non-transitory memory included in the logic configured to store information 415 can correspond to RAM, flash memory, ROM, erasable programmable ROM (EPROM), EEPROM, registers, hard disk, a removable disk, a CD-ROM, or any other form of storage medium known in the art. The logic configured to store information 415 can also include software that, when executed, permits the associated hardware of the logic configured to store information 415 to perform its storage function(s). However, the logic configured to store information 415 does not correspond to software alone, and the logic configured to store information 415 relies at least in part upon hardware to achieve its functionality.

Referring to FIG. 4, the communication device 400 further optionally includes logic configured to present information 420. In an example, the logic configured to present information 420 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 400. For example, if the communication device 400 corresponds to the IoT device 200A as shown in FIG. 2A and/or the passive IoT device 200B as shown in FIG. 2B, the logic configured to present information 420 can include the display 226. In a further example, the logic configured to present information 420 can be omitted for certain communication devices, such as network communication devices that do not have a local user (e.g., network switches or routers, remote servers, etc.). The logic configured to present information 420 can also include software that, when executed, permits the associated hardware of the logic configured to present information 420 to perform its presentation function(s). However, the logic configured to present information 420 does not correspond to software alone, and the logic configured to present information 420 relies at least in part upon hardware to achieve its functionality.

Referring to FIG. 4, the communication device 400 further optionally includes logic configured to receive local user input 425. In an example, the logic configured to receive local user input 425 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 400. For example, if the communication device 400 corresponds to the IoT device 200A as shown in FIG. 2A and/or the passive IoT device 200B as shown in FIG. 2B, the logic configured to receive local user input 425 can include the buttons 222, 224A, and 224B, the display 226 (if a touchscreen), etc. In a further example, the logic configured to receive local user input 425 can be omitted for certain communication devices, such as network communication devices that do not have a local user (e.g., network switches or routers, remote servers, etc.). The logic configured to receive local user input 425 can also include software that, when executed, permits the associated hardware of the logic configured to receive local user input 425 to perform its input reception function(s). However, the logic configured to receive local user input 425 does not correspond to software alone, and the logic configured to receive local user input 425 relies at least in part upon hardware to achieve its functionality.

Referring to FIG. 4, while the configured logics of 405 through 425 are shown as separate or distinct blocks in FIG. 4, it will be appreciated that the hardware and/or software by which the respective configured logic performs its functionality can overlap in part. For example, any software used to facilitate the functionality of the configured logics of 405 through 425 can be stored in the non-transitory memory associated with the logic configured to store information 415, such that the configured logics of 405 through 425 each performs their functionality (i.e., in this case, software execution) based in part upon the operation of software stored by the logic configured to store information 415. Likewise, hardware that is directly associated with one of the configured logics can be borrowed or used by other configured logics from time to time. For example, the processor of the logic configured to process information 410 can format data into an appropriate format before being transmitted by the logic configured to receive and/or transmit information 405, such that the logic configured to receive and/or transmit information 405 performs its functionality (i.e., in this case, transmission of data) based in part upon the operation of hardware (i.e., the processor) associated with the logic configured to process information 410.

Generally, unless stated otherwise explicitly, the phrase “logic configured to” as used throughout this disclosure is intended to invoke an aspect that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the aspects described below in more detail.

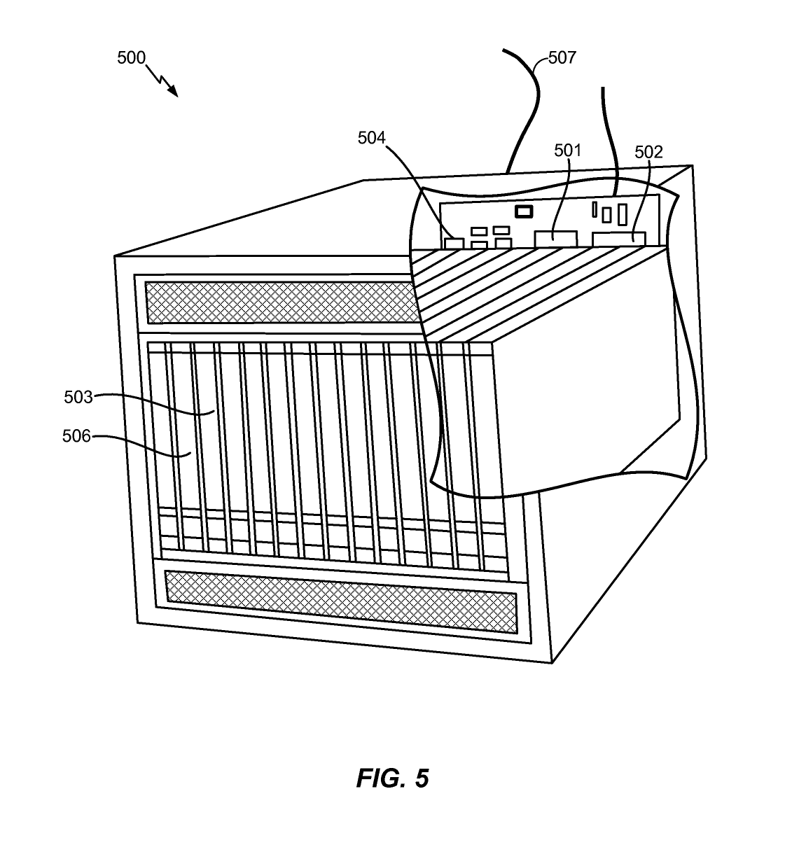

The various embodiments may be implemented on any of a variety of commercially available server devices, such as server 500 illustrated in FIG. 5. In an example, the server 500 may correspond to one example configuration of the IoT server 170 described above. In FIG. 5, the server 500 includes a processor 500 coupled to volatile memory 502 and a large capacity nonvolatile memory, such as a disk drive 503. The server 500 may also include a floppy disc drive, compact disc (CD) or DVD disc drive 506 coupled to the processor 501. The server 500 may also include network access ports 504 coupled to the processor 501 for establishing data connections with a network 507, such as a local area network coupled to other broadcast system computers and servers or to the Internet. In context with FIG. 4, it will be appreciated that the server 500 of FIG. 5 illustrates one example implementation of the communication device 400, whereby the logic configured to transmit and/or receive information 405 corresponds to the network access points 504 used by the server 500 to communicate with the network 507, the logic configured to process information 410 corresponds to the processor 501, and the logic configuration to store information 415 corresponds to any combination of the volatile memory 502, the disk drive 503 and/or the disc drive 506. The optional logic configured to present information 420 and the optional logic configured to receive local user input 425 are not shown explicitly in FIG. 5 and may or may not be included therein. Thus, FIG. 5 helps to demonstrate that the communication device 400 may be implemented as a server, in addition to an IoT device implementation as in FIG. 2A.

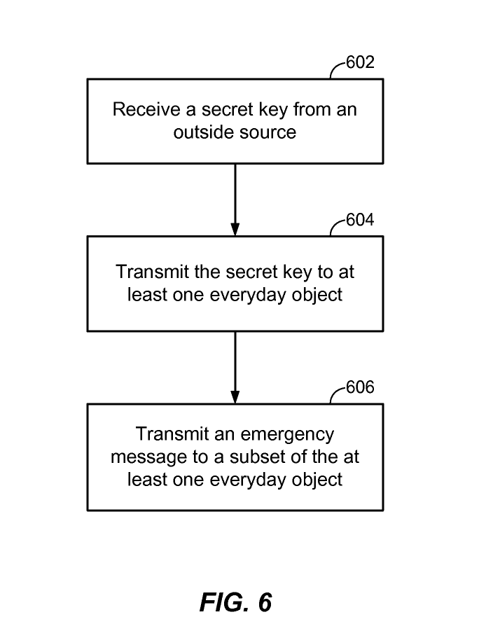

As illustrated in FIG. 6, an embodiment can include a method for transmitting an emergency instruction to an IoT device comprising: receiving an IoT secret key from an outside source (e.g., receiving an IoT secret key from an electric company)—Block 602; transmitting the IoT secret key to at least one IoT device (e.g., transmitting the key to all air conditioning units)—Block 604; and transmitting an emergency message, including an emergency secret key, to a subset of the at least one IoT device (e.g., transmitting a brownout message to a specified number of AC units, including permutations of the time of brown out and number of units needed to reduce consumption in order to reduce brownout time, where the emergency secret key is encrypted in the IoT device's secret key)—Block 606. In some embodiments, an emergency message can be a broadcast/multicast/unicast emergency message. Routing this emergency message to IoT devices may be network-specific. In some embodiments, the emergency message can include quality of service parameters to allow priority routing of the emergency message to each IoT device.

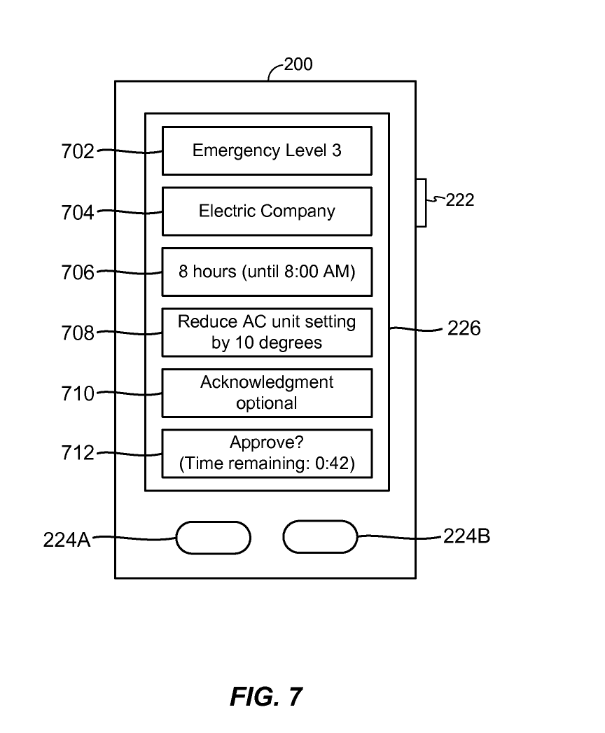

FIG. 7 illustrates a communication device display that shows at least some of the emergency message information from the trusted authority source regarding the device. As shown, the device display 226 from FIG. 2 provides six sections. Each section provides information to the user from the emergency message. Although the display 226 is text-based, embodiments can use color, sound, animation, and other means to provide emergency information to the user.

In FIG. 7, section 702 displays the level of emergency, shown here to be “Emergency Level 3”. Section 704 shows the level of authority issuing emergency message, herein “Electric Company”. The level of authority can be the same as a trusted authority source or the information provider to the trusted authority source.

The expected duration of an emergency can be indicated in FIG. 7 in section 706, which shows the suggested time that IoT device should stay in emergency mode operation. The recommended generic action that IoT device should perform is illustrated in section 708: “Reduce AC unit setting by 10 degrees.” The display 226 can also inform a user whether acknowledgement is required or requested in section 710.

The emergency message can include a suggested action for the IoT device in case a user response is not received by the IoT device within given duration of time. Shown in section 712, the user has 42 seconds left until his approval is no longer taken into consideration for the emergency instruction. If the user's approval is required, then the emergency instruction may not be implemented. If the user's approval is not required, then the emergency instruction can be implemented.

The IoT device can transmit a response message to the trusted authority source. The response can include details of responses from the user and the IoT device. For example, the user's response to acknowledge the emergency message and to approve the suggested action can be sent to the trusted authority source. The information that the IoT device can provide the trusted authority source can assist in implementing resources. For example, a fire department system can generate a report that shows which IoT devices that have been sent an emergency message have not been able to take the required action such as a gas shut-off. Based on that report, the fire department can dispatch resources for manual intervention.

In some implementations, it may be desirable to override an everyday device's emergency mode. Once the emergency mode is initiated, the emergency mode may be overridden using an override instruction. For example, the trusted authority source may be the outside source that provides an override instruction once an authority has determined the emergency is over. The user can also provide an override signal if the user has determined he does not wish to implement the emergency mode. The everyday device can override the emergency mode if another parameter is determined. For example, the everyday device can be a refrigerator that has shut off to conserve power for a potential brown out, but determine that a low power usage and a further decrease in air conditioning would meet user-defined parameters. Using these parameters, the refrigerator can override the emergency mode and still achieve the same desired reduction in power consumption.

In some implementations, the IoT device can transmit an emergency instruction to a non-everyday device based on the emergency message. The IoT device can be a computer that also controls home lights. The light switches may not be IoT devices. That is, the lights do not communicate with the Internet, nor are they capable of receiving IoT secret keys. If the computer receives an emergency message, however, the computer can send a message to lights to remain off during an electrical storm rather than turning on at a predetermined time.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an electronic object. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, DVD, floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method for implementing an emergency instruction based on an emergency message from a trusted authority source, the method comprising:
receiving, at an Internet of Things (IoT) device, an IoT secret key from a trusted authority source;
receiving, at an IoT device, an emergency message from the trusted authority source, the emergency message comprising an emergency secret key;
decoding, at an IoT device, the emergency message from the trusted authority source using the IoT secret key to determine a value within the emergency message;
calculating, at an IoT device, a result based on the determined value; and
implementing, at an IoT device, an emergency instruction if the result is above a predetermined threshold.

2. The method of claim 1, wherein a different IoT secret key is periodically sent to the IoT device.

3. The method of claim 1, wherein the IoT secret key is validated from a second trusted authority source.

4. The method of claim 1, further comprising, at an IoT device:
ascertaining data from at least one of the following: the IoT device, another IoT device on a same LAN, and a non-IoT device on the same LAN; and
incorporating the value as a variable into an equation along with the ascertained data.

5. The method of claim 1, wherein the emergency instruction comprises at least one of the following: a shut-off instruction, a turn on instruction, an increase output instruction, a decrease output instruction, and an alert instruction.

6. The method of claim 1, wherein the emergency message is a broadcast/multicast/unicast message to more than one IoT device.

7. The method of claim 6, wherein the emergency message is network-specific.

8. The method of claim 1, wherein the emergency instruction is transmitted to at least one non-IoT device.

9. The method of claim 1, wherein the emergency secret key is encrypted in the IoT secret key.

10. The method of claim 1, further comprising interpreting, at an IoT device, the emergency message using global IoT vocabulary.

11. The method of claim 1, further comprising:
receiving, at an IoT device, an override instruction from an outside source; and
overriding, at an IoT device, the emergency instruction based on the override instruction.

12. The method of claim 11, wherein the override instruction is from the trusted authority source.

13. The method of claim 1, wherein the everyday device operates in an emergency mode while implementing the emergency instruction.

14. The method of claim 1, wherein the degree to which an instruction is implemented is based on the determined value.

15. The method of claim 1, wherein the emergency message may comprise at least one of the following: a level of emergency, a level of authority issuing the emergency message, a expected duration of the emergency, a recommended generic action to perform, a request for acknowledgement, a request for user authorization, and a request for response.

16. The method of claim 1, wherein the IoT device transmits a response message to the trusted authority source.

17. The method of claim 16, wherein the information that the IoT device provides the trusted authority source assists in implementing resources.

18. The method of claim 1, wherein the emergency message includes quality of service parameters to allow priority routing of the emergency message to the IoT device.

19. An apparatus comprising:
a processor configured to implementing an emergency instruction based on an emergency message from a trusted authority source;
logic configured to receive an IoT secret key from a trusted authority source;
logic configured to receive an emergency message from the trusted authority source, wherein the emergency message comprises an emergency secret key;
logic configured to decode the emergency message from the trusted authority source using the IoT secret key to determine a value within the emergency message;
logic for calculating a result based on the determined value; and
logic for implementing an emergency instruction if the result is above a predetermined threshold.

20. The apparatus of claim 19, wherein a different IoT secret key is periodically sent to the IoT device.

21. The apparatus of claim 19, wherein the IoT secret key is validated from a second trusted authority source.

22. The apparatus of claim 19, further comprising:
logic configured to ascertain data from at least one of the following: the IoT device, another IoT device on a same LAN, and a non-IoT device on the same LAN; and
logic configured to incorporate the value as a variable into an equation along with the ascertained data.

23. The apparatus of claim 19, wherein the emergency instruction is transmitted to at least one non-IoT device.

24. The apparatus of claim 19, wherein the emergency secret key is encrypted in the IoT device's secret key.

25. The apparatus of claim 19, further comprising:
logic configured to receive an override instruction from an outside source; and
logic configured to override the emergency instruction based on the override instruction.

26. The apparatus of claim 25, wherein the outside source is the trusted authority source.

27. The apparatus of claim 19, wherein the degree to which an instruction is implemented is based on the determined value.

28. The apparatus of claim 19, wherein the emergency message may comprise at least one of the following: a level of emergency, a level of authority issuing the emergency message, a expected duration of the emergency, a recommended generic action to perform, a request for acknowledgement, a request for user authorization, and a request for response.

29. A method for a trusted authority source to transmit an emergency message, the method comprising:
receiving, from an outside source, an IoT secret key;
transmitting, from the trusted authority source, the IoT secret key to at least one IoT device;
receiving, from the outside source, an emergency secret key, wherein the emergency message comprises an emergency secret key.
transmitting, from the trusted authority source, an emergency message to a subset of the at least one IoT device, wherein the emergency message comprises the secret key.

30. An apparatus comprising:
a processor configured to transmit an emergency message to an IoT device;
logic configured to receive an IoT secret key;
logic configured to transmit the IoT secret key to at least one IoT device;
logic configured to receive an emergency message, wherein the emergency message comprises an emergency secret key; and
logic configured to transmit the emergency message to a subset of the at least one IoT device.
